(19) United States
(12) Patent Application Publication
(10) Pub. No.: US 2017/0240458 A1
(43) Pub. Date: Aug. 24, 2017

(54) Method of Making Surface-Active Glasses as Regenerative Anti-Fouling Materials

(71) Applicant: The Government of the United States of America, as represented by the Secretary of the Navy, Washington, DC (US)

(72) Inventor: Kenan P. Fears, Woodbridge, VA (US)

(73) Assignee: The Government of the United States of America, as represented by the Secretary of the Navy, Washington, DC (US)

(21) Appl. No.: 15/495,374

(22) Filed: Apr. 24, 2017

Related U.S. Application Data
(63) Continuation of application No. 14/504,657, filed on Oct. 2, 2014.
(60) Provisional application No. 61/889,591, filed on Oct. 11, 2013.

(51) Int. Cl. C03C 3/145; C03C 4/00; A01N 25/08; A01N 59/20; A01N 59/16

(52) U.S. Cl. CPC C03C 3/145; A01N 59/20; A01N 59/16; A01N 25/08; C03C 4/0035; C03C 2204/02; C03B 25/02

(57) ABSTRACT

A method of making a surface-active glass as regenerative anti-fouling material comprising mixing Na₂O and B₂O₃, creating a surface-active glass with a water-soluble glass matrix, wherein the surface-active glass comprises a sodium borate glass consisting of 25 mol % Na₂O and 75 mol % B₂O₃ or wherein the surface-active glass comprises a sodium aluminoborate glass consisting of 10-30 mol % Al₂O₃, 10-30 mol % Na₂O and 70-40 mol % B₂O₃.

This application claims priority to and the benefits of U.S. Patent Application No. 61/889,591 filed on Oct. 11, 2013, and U.S. patent application Ser. No. 14/504,657 filed on Oct. 2, 2014, the entirety of each is herein incorporated by reference.

### BACKGROUND

This invention relates to the use of surface-active glasses, those that react in aqueous environments, as materials for anti-fouling applications.

Glass compositions are detailed that resist marine fouling, with or without forming gelatinous reaction layers as a byproduct of their dissolution. The chemistry of the reaction layer can be varied to alter the physical and chemical properties at the liquid interface, as well the dissolution rate of the glasses.

Removal of the reaction layer, by a foulant or other mechanical means for the purpose of cleaning the surface, presents a glass surface that will regenerate a reaction layer in the presence of water.

The biofouling of exposed surfaces on marine vessels, as well as other underwater devices and structures is a costly problem that can hamper the performance of the aforementioned technologies. Due to low hydrodynamic flow rates and the presence of hard fouling communities (e.g. barnacles and tube worms), surfaces that occupy the littoral region often experience high fouling pressures. Biofouling creates drag and compromises energy efficiency of mobile vessels, but poses an even larger threat to the functionality (e.g. communication and observational capabilities) of vessels and devices while stationary in the littoral environment.

Formerly, paints that release toxic biocides (e.g. tributylin tin) were used extensively in marine applications to prevent biofouling, but the negative ecological impact of these biocidal compounds has led to their increased global regulation. Self-polishing polymeric coatings, such as those described by Jiang et al. (U.S. Pat. No. 8,349,966), have emerged as possible alternatives, but currently still require biocide additives (e.g. Cu) to limit general biofouling, as do many resin-based systems.

Tough polyurethanes with silicone surface films are also promising; however, they do not efficiently prevent hard fouling when the object is not in motion. These prior art surface films are soft and highly susceptible to damage, leading to compromised adherent release properties [Buskens et al., “A brief review of environmentally benign antifouling and foul-release coatings for marine applications”, J Coat Technol Res, 10, 29 (2013)].

The challenge facing researchers is to develop antifouling surfaces that are both robust and environmentally benign. This task becomes even more daunting if the desired material must display optical transparency; however, this goal may be achievable using surface-active glasses that are capable of presenting dynamic interfaces while maintaining bulk properties inherent to glasses.

The prior art of Day and Conzone, U.S. Pat. No. 6,358,531, detail the non-uniform reaction process of alkali borate glass particles incorporated with other metal oxides. These glasses were designed so that the glass matrix would quickly dissolve in aqueous solutions, releasing metal cations that react with anions in the surrounding solution to form insoluble amorphous and/or crystalline bodies with the same dimensions as the initial glass particles. While fast-reacting glasses that completely dissolve are not ideal for anti-fouling applications, surface-active glasses that form thin, diffusion-limiting reaction layers would be highly advantageous as they would preserve the optical properties of the initial glasses and lengthen the operational lifetime of the glasses.

### BRIEF SUMMARY OF THE INVENTION

An anti-fouling material wherein the material consists of, in whole or in part, a surface-active glass with a water-soluble glass matrix.

The material as above wherein a carbonaceous compound (e.g. graphite, coke), or a combination thereof, is added to the glass batch to manipulate the dissolution rate of the glass matrix.

The material as herein described wherein the glass is doped with a biocidal additive (e.g. Cu, Ag), or a combination thereof.

### BRIEF DESCRIPTION OF THE DRAWINGS

FIG. 1 illustrates a plot of the weight loss per unit surface area versus the time that 7.5B substrates were immersed in ASW at 23° C.

FIGS. 2A, 2B, 2C, and 2D illustrate images of a 7.5B substrate after a barnacle was re-settled on the surface and incubated in ASW at 23° C. for FIG. 2A 24 h, FIG. 2B 48 h, FIG. 2C 72 h, and FIG. 2D 120 h—at which time the barnacle was removed. Mineral deposits accumulated on the glass surface throughout the incubation period, rendering the glass opaque by 72 h. FIG. 2E is an image of the substrate after it was cleaned with a cotton swab, while remaining immersed in ASW.

FIG. 3A illustrates the EDS spectra of 2A16B before exposure to ASW and FIG. 3B illustrates the EDS spectra of 2A16B after incubating for 72 hours in ASW at 23° C.

FIG. 4 illustrates a plot of the weight loss per unit surface area versus the time that 2A16B substrates were immersed in ASW at 23° C.

FIG. 5A illustrates a SEM image of the surface of a 2A16B substrate after incubating for 72 h in ASW at 23° C. and FIG. 5B is a cross section image at the external surface of the reaction layer. The substrate was rinsed thoroughly with 18 MΩ-cm water and dried at 37° C., which caused the reaction layer to shrink and crack, prior to mounting on a SEM stub and sputter coating to form a 3.0 nm Au conductive layer.

FIG. 6A illustrates images of barnacles re-settled on 2A16B and FIG. 6B illustrates images of barnacles re-settled on 3A14B substrates and incubated in ASW at 23° C. for 2 weeks. Biologically matter was removed off the FIG. 6C 2A16B and FIG. 6D 3A14B substrates using a cotton swab.

FIG. 7A illustrates SEM images of the cross section of reaction layers that formed on 2A16B and FIG. 7B illustrates SEM images of the cross section of reaction layers that formed on 3A14B substrates after incubating for 72 h in ASW at 23 C.

FIG. 8 illustrates the stress required to remove barnacles that were re-settled on 2A16B and 3A14B substrates for 3 days and 2 weeks in comparison to critical removal stresses reported for barnacles re-settled on a commercial silicone coating [Rittschof et al., “Barnacle reattachment: a tool for studying barnacle”, Biofouling, 24, 1 (2008)]. Numbers above the bars indicate sample size.

FIG. 9A is an SEM image of the cross section of reaction layers that formed on 2A16B-G substrates after incubating in ASW at 23 C. for 72 hours.

FIG. 9B is an SEM image of the cross section of reaction layers that formed on 2A16B-G substrates after incubating in ASW at 23 C. for 1 month.

FIG. 10A illustrates SEM images of the cross section of reaction layers that formed on 2A16B-G substrates after incubating in ASW at 23 C. for 72 h and FIG. 10B illustrates SEM images of the cross section of reaction layers that formed on 2A16B-G substrates after incubating in ASW at 23 C. for 1 month.

FIG. 11A illustrates the EDS spectra of 2A16B before exposure to ASW and FIG. 11B illustrates the EDS spectra of 2A16B after incubating for 72 hours in ASW at 23° C.

FIG. 12 illustrates an image of a barnacle that cut through a 0.5 mm silicone coating, permanently adhering to the underlying glass substrate.

### DETAILED DESCRIPTION

This invention relates to the use of surface-active glasses, those that react in aqueous environments, as materials for anti-fouling applications.

Glass compositions are detailed that resist marine fouling, with or without forming gelatinous reaction layers as a byproduct of their dissolution. The chemistry of the reaction layer can be varied to alter the physical and chemical properties at the liquid interface, as well the dissolution rate of the glasses.

Removal of the reaction layer, by a foulant or other mechanical means for the purpose of cleaning the surface, presents a glass surface that will regenerate a reaction layer in the presence of water.

The surface-active glasses detailed in the present invention comprise water soluble glass compositions with the glass former, B₂O₃, P₂O₅, SiO₂, GeO₂, V₂O₅, or a combination thereof, constituting 20 to 99 mol % of the glass.

The glasses can contain alkali fluxing agents consisting of any of the alkali metal oxides (i.e. Li₂O, Na₂O, K₂O, etc.), or a combination thereof.

The glasses also can contain an additional metal oxide modifier, including oxides of alkaline earth metals, rare earth metals, transition metals, actinides, and lanthanides, or a combination thereof.

The surface-active glasses in the present invention can be prepared by batching raw materials typically used for glass manufacturing, such as metal oxides or carbonates, nitrates, and/or sulfates that will decompose into the desired metal oxides (including alkalis), along with the glass former(s), such as boric acid (H₃BO₃) as the source of B₂O₃.

As described herein, the invention concerns an anti-fouling material wherein the material consists of, in whole or in part, a surface-active glass with a water-soluble glass matrix. The material as described above wherein a carbonaceous compound (e.g. graphite, coke), or a combination thereof, is added to the glass batch to manipulate the dissolution rate of the glass matrix.

One embodiment includes wherein the glass is doped with a biocidal additive (e.g. Cu, Ag), or a combination thereof.

Another embodiment includes wherein a carbonaceous compound, or a combination thereof, is added to the glass batch to manipulate the dissolution rate of the glass matrix.

The surface-active glass can contain an additional glass modifier (e.g. alkaline earth metals, rare earth metals, transition metals, actinides, and lanthanides), or a combination thereof, that form a reaction layer as the glass matrix dissolves.

This material with the glass modifier can also include a carbonaceous compound, or a combination thereof, added to the glass batch to manipulate the dissolution rate of the glass matrix and the glass can be doped with a biocidal additive (e.g. Cu, Ag), or a combination thereof.

### Example #1

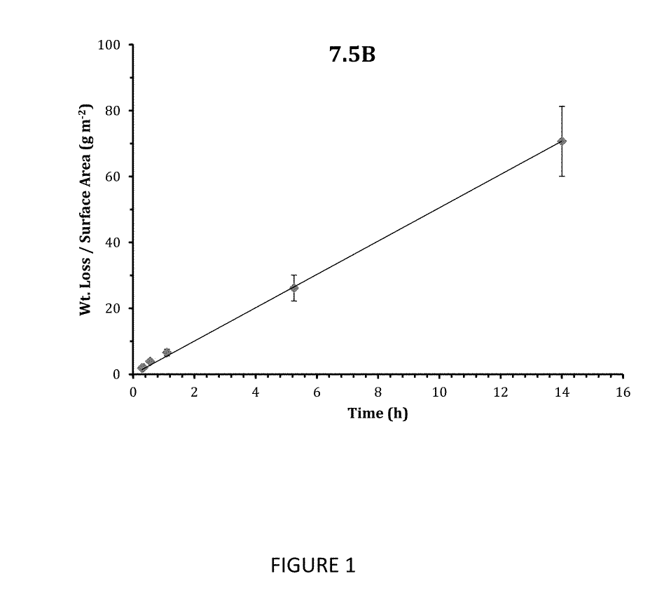

A sodium borate glass—25 mol % Na₂O; 75 mol % B₂O₃, denoted herein as 7.5B—was prepared by batching the appropriate amounts of Na₂CO₃ and H₃BO₃ in an alumina crucible and melting the batch at 1000° C. Ingots were formed by pouring the melts onto graphite slabs and annealing the ingots at 500° C. for several hours before allowing them to cool to room temperature. 7.5B formed a clear glass with a low chemical durability; dissolution rate in artificial sea water (ASW; pH 8.2) was 6.6±0.5 g h⁻¹ m⁻² (mean ±95% CI). Since neither sodium or boron ions form insoluble phases with hydroxyl, sulfate, carbonate, nor halide (mainly chloride) anions present in ASW, 7.5B dissolved without forming a reaction layer. FIG. 1 shows that dissolution of the glass continued at a steady rate over the course of 14 hours, indicating that the dissolution is rate-limited.

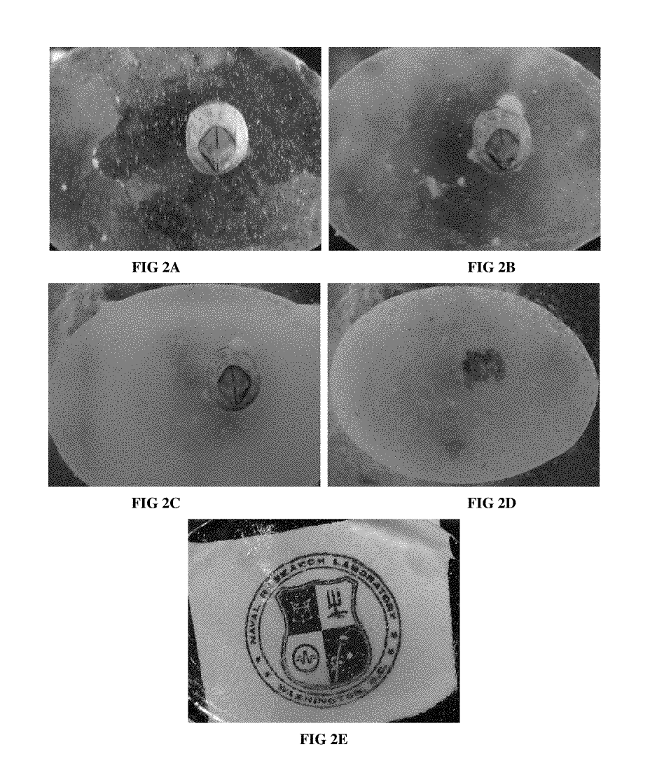

The bioadhesion resistance of 7.5B, as well as other glasses detailed herein, were assessed by performing re-settlement assays with Balanus amphitrite (acorn barnacle), according to protocols detailed by Burden et al. [Burden et al., “Barnacle Balanus amphitrite Adheres by a Stepwise Cementing Process”, Langmuir, 28, 13364 (2012)]. Briefly, adult barnacles, grown on silicone panels, were transferred to glass substrates and placed in an incubator at 23° C. for up to 2 weeks. In the presence of a barnacle, a calcium-rich mineral layer accumulated at the highly basic glass-liquid interface. FIG. 2a shows that after incubating in ASW for 24 h the deposition of mineral deposits consisting of calcium and magnesium carbonates can clearly be observed on the glass surface, and after 72 h the mineral layer completely covered the glass surface, rendering it opaque (FIG. 2c). The loosely adhered barnacle was removed from the surface after 120 h by agitating the solution (FIG. 2d); mineral layer was removed by running a cotton swab over the surface, while immersed in ASW, revealing the transparent glass substrate (FIG. 2e). While highly effective at preventing barnacle adhesion, the fast dissolution rate resulted in non-uniform degradation of the glass surface, due to irregular flow patterns induced by the barnacle, attributing to the loss in clarity (FIG. 2e).

### Example #2

Sodium aluminoborate glasses—10 mol % Al₂O₃, 20 mol % Na₂O; 70 mol % B₂O₃, denoted herein as 1A17B; 20 mol % Al₂O₃, 20 mol % Na₂O; 60 mol % B₂O₃, denoted herein as 2A16B; 30 mol % Al₂O₃, 30 mol % Na₂O; 40 mol % B₂O₃, denoted herein as 3A14B—were prepared by batching the appropriate amounts of Al₂O₃, Na₂CO₃, and H₃BO₃ in an alumina crucible and melting the batch at 1250° C. (1A17B and 2A16B) or 1350° C. (3A14B). Ingots were formed by pouring the melts onto graphite slabs and annealing the ingots at 500° C. for several hours before allowing them to cool to room temperature. The addition of a glass modifier, Al₂O₃, resulted in the formation of clear glasses with improved chemical durability with respect to 7.5B; initial dissolution rates measured over 30 min in ASW were ca. 6.9, 6.3, and 1.6 g h⁻¹ m⁻² for 1A17B, 2A16B, and 3A14B, respectively.

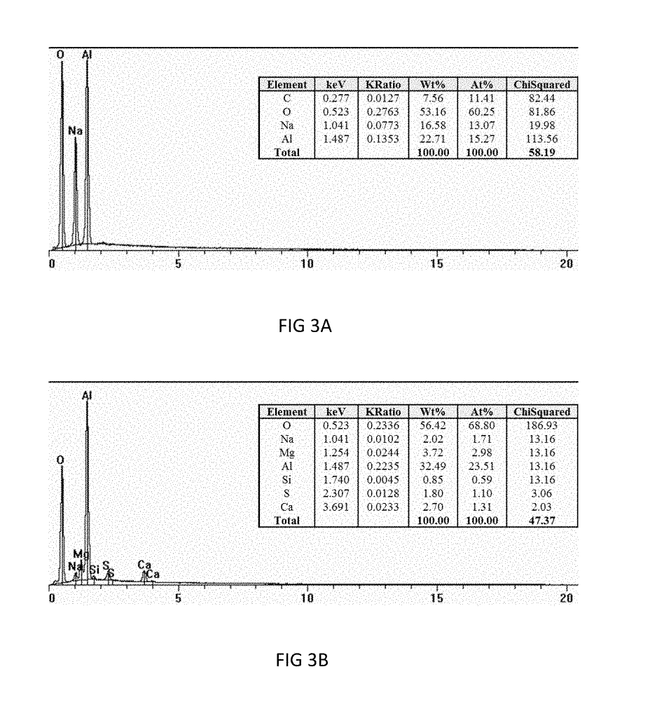

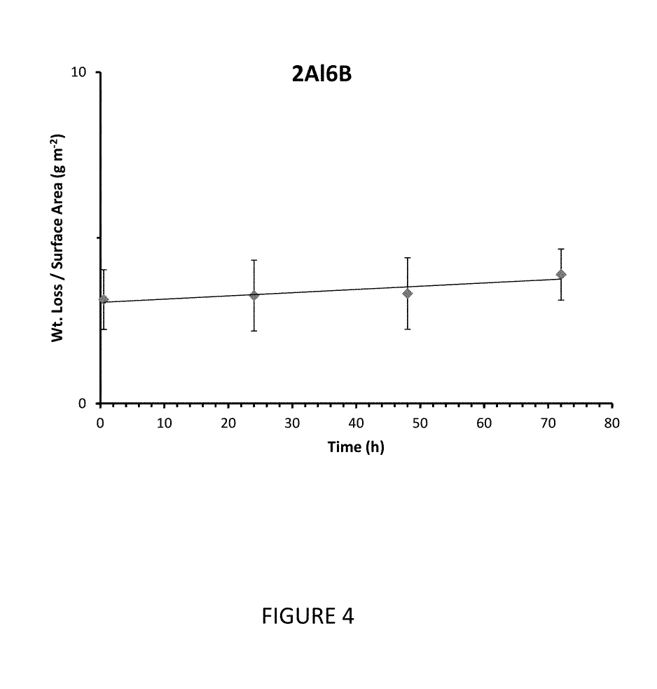

Energy dispersive X-ray spectroscopy (EDS) showed that there were equal amounts of Al and Na present in unreacted 2A16B (FIG. 3a), whereas after incubating for 72 h in ASW there was a depletion of Na at the surface which is consistent with the dissolution of the glass matrix (FIG. 3b). Due to its low solubility in water, aluminum hydroxide (Kₛₚ of Al(OH)₃=4.6×10⁻³³) is likely the primary component of the reaction layer, which is supported by the predominance of oxygen, followed by aluminum, in the reaction layer (FIG. 3b). While the dissolution of 7.5B was rate-limited (FIG. 1), the reaction layer that formed on 2A16B created a diffusion barrier limiting the dissolution of the glasses; FIG. 4 shows that there was minimal weight loss observed between 0.5 and 72 h. These data indicate that while the initial reaction rate of 2A16B is comparable to 7.5B it quickly forms a diffusion barrier limiting surface degradation; thus, increasing the operational lifetime of the glass substrate.

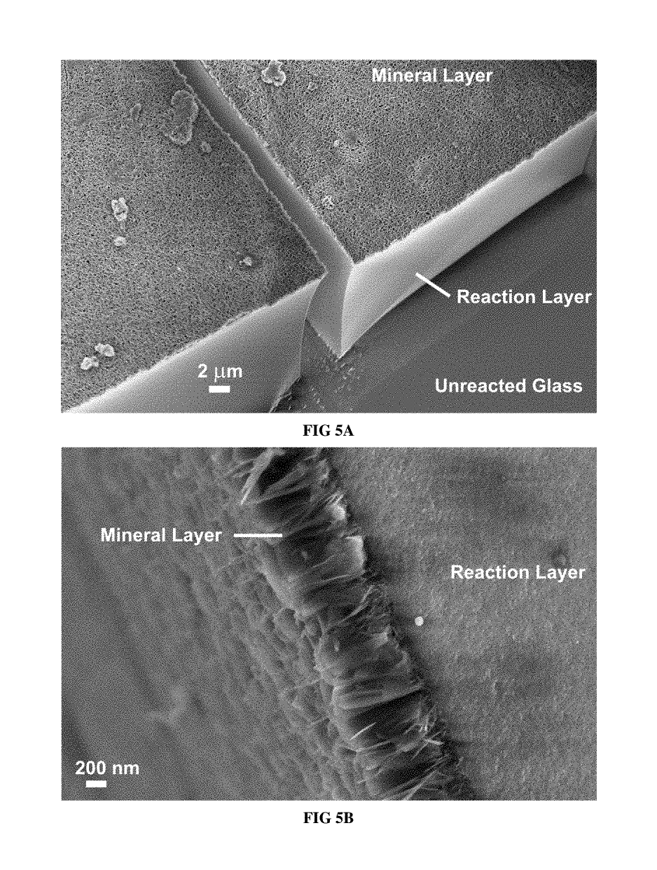

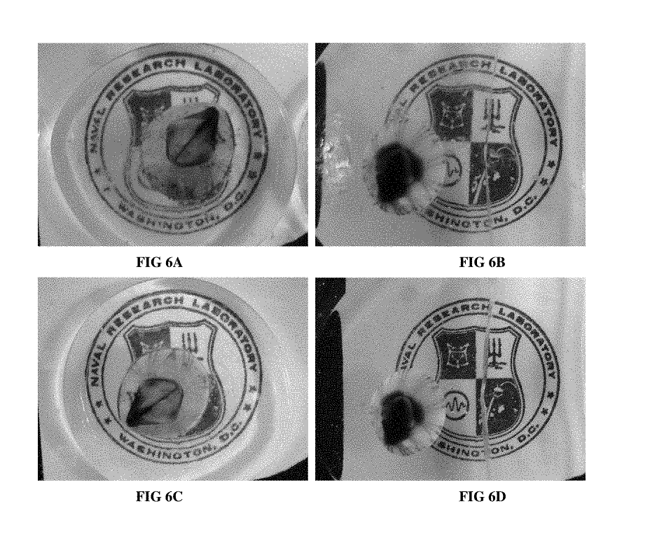

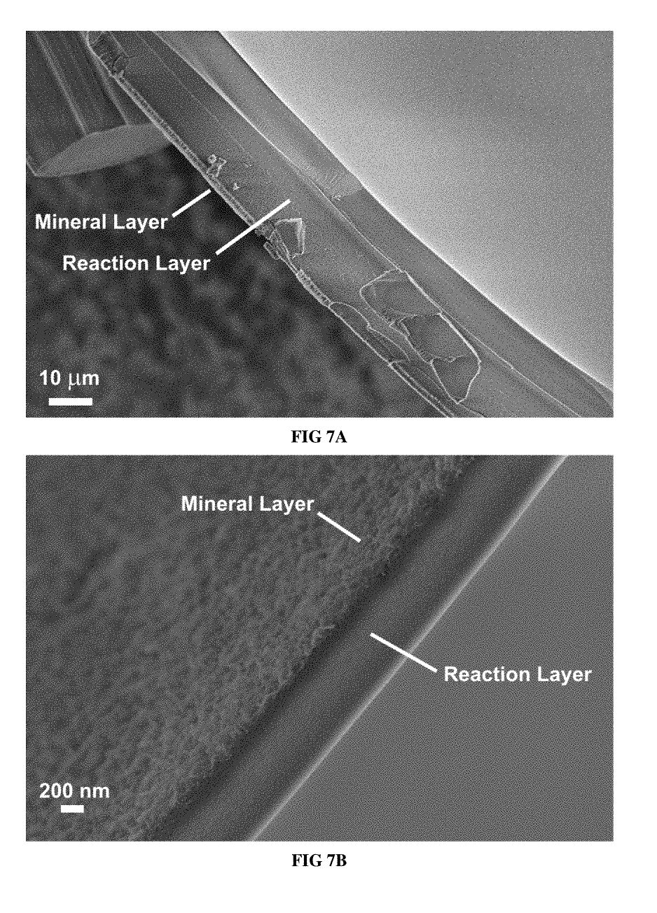

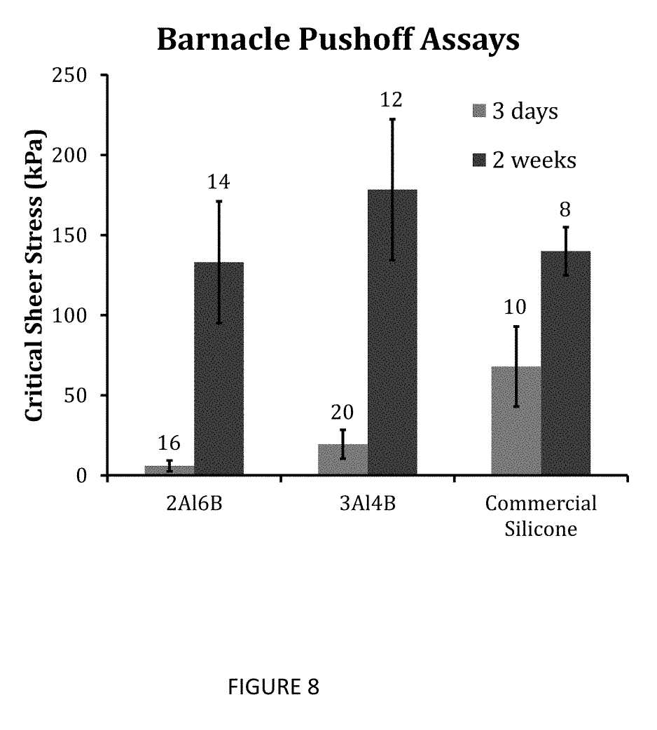

As shown in FIGS. 5a & 5b, a mineral deposition layer formed at the interface between the reaction layer and ASW; however, in control experiments, 2A16B remained transparent after 2 weeks in ASW, whereas the reaction of 1A17B resulted in aluminum reaction products being dispersed throughout the solution. FIGS. 6a & 6b show that 2A16B and 3A14B substrates retained their optical transparency during 2 week long barnacle adhesion assays. Biological matter that accumulated on the surface throughout the incubation period was easily removed by running a cotton swab over the glass surface (FIGS. 6c & 6d). Due to the increase in the Al₂O₃ content, the reaction layer that formed on 3A14B was thinner than 2A16B, ca. 700 nm v. 25 μm (FIGS. 7a & 7b), respectively; however, there was no significant difference in performance of the two glasses in barnacle adhesion assays. As shown in FIG. 8, critical removal stresses measured after barnacles re-settled on 2A16B and 3A14B substrates for 3 days were substantially lower than the value reported for a commercial silicone coating and comparable to the silicone coating at 2 weeks [Rittschof et al., “Barnacle reattachment: a tool for studying barnacle”, Biofouling, 24, 1 (2008)].

Example #3

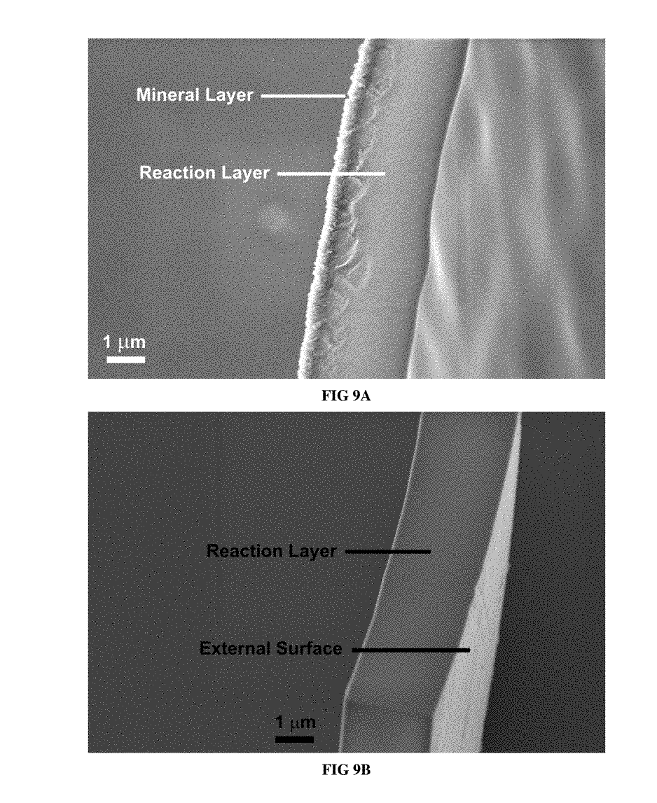

I have discovered an alternative way to control the reaction properties of surface-active glasses. The reaction depth can be varied for two glasses with the same glass composition through the addition of carbonaceous material to the glass batch, in excess of amounts generally added for glass refinement—generally a small fraction of a weight percent is added for refinement, because large quantities can result in coloration of the glass. A sodium aluminoborate glass (20 mol % Al₂O₃, 20 mol % Na₂O, 60 mol % B₂O₃) was made in the same manner as the 2A16B except with the addition of 2 wt. % graphite to the glass batch, denoted herein as 2A16B-G. The addition of graphite to the batch resulted in the formation of an amber glass, which is indicated by the absorbance band at 407 nm in the spectrum of 2A16B-G (FIG. 9). In contrast to 2A16B, 2A16B-G also exhibited strong absorbance in the UV light range below 350 nm; however, both glasses exhibited high transmission in the visible and near infrared light ranges from 400 nm to 1700 nm.

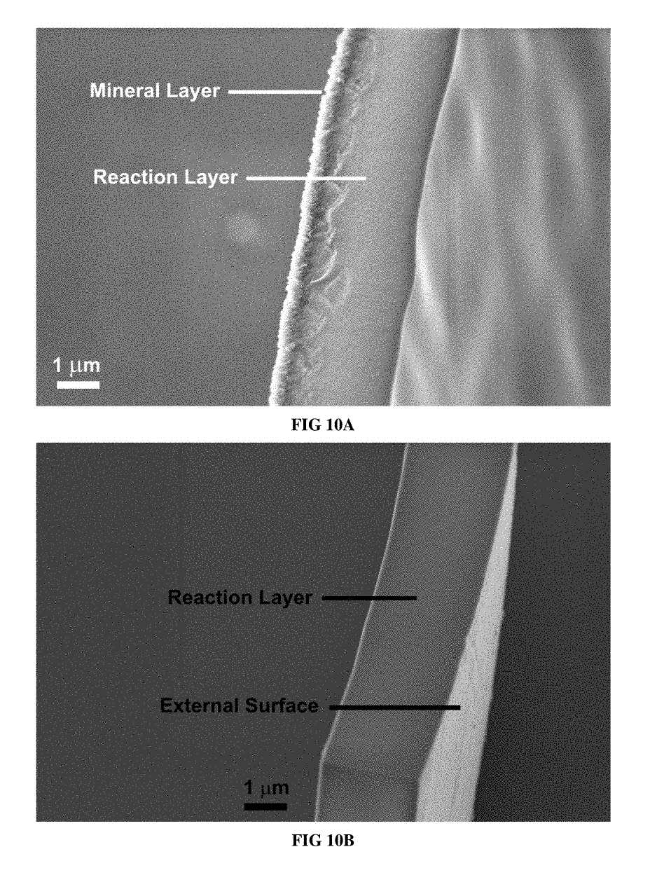

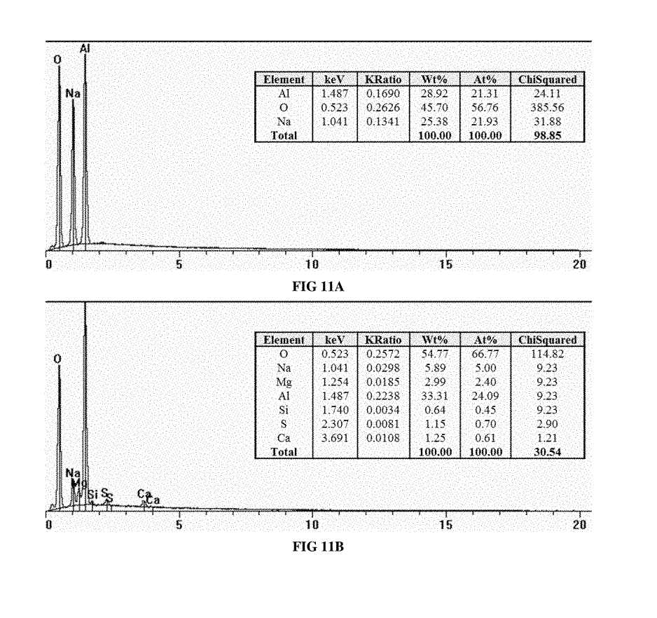

The dissolution rate of 2A16B-G was considerably slower than 2A16B; initial dissolution rate measured over 30 minutes in ASW was ca. 0.9 v. 6.3 g h⁻¹ m⁻², respectively. When incubated in ASW for 72 h, 2A16B-G formed a reaction layer that was ca. 2.5 μm thick versus 25 μm for 2A16B (FIG. 10a) and the thickness was consistent over 1 month incubation period (FIG. 10b), providing further evidence that the reaction process is diffusion limited. Additionally, the EDS spectra of 2A16B-G before (FIG. 11a) and after reacting in ASW for 72 h (FIG. 11b) were consistent with the spectra for 2A16B (FIG. 2), suggesting that similar chemistries are presented at the interface between the reaction layer and the liquid. The stress required to remove barnacles re-settled on 2A16B-G substrates was significantly higher than for barnacles re-settled on 2A16B substrates, 38.1±10 kPa and 6.0±3 kPa, respectively. However, the critical removal stresses for both aluminoborate glasses were below the reported values for a commercial silicone coating, ca. 60 kPa [Rittschof et al., “Barnacle reattachment: a tool for studying barnacle”, Biofouling, 24, 1 (2008)], and CaF₂ optical windows, ca. 200 kPa [Burden et al., “Barnacle Balanus amphitrite Adheres by a Stepwise Cementing Process”, Langmuir, 28, 13364 (2012)].

The surface-active glasses described in this disclosure present a novel way by which interfaces that resist biofouling can be created.

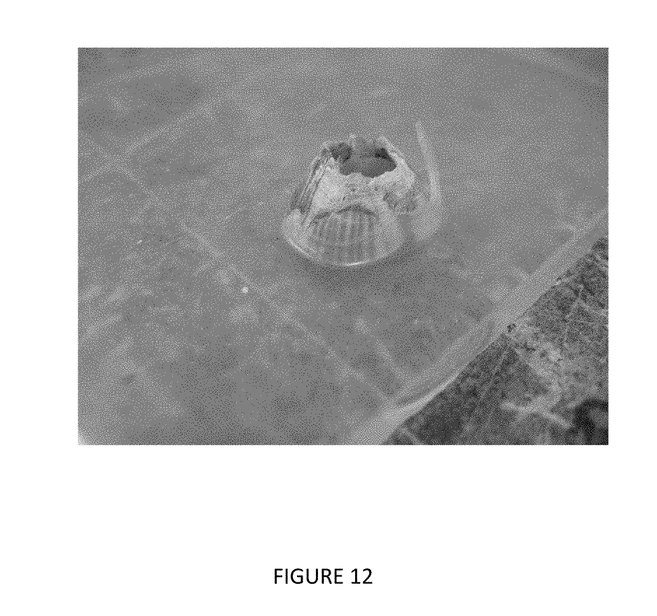

The critical shear stresses required to remove barnacles re-settled on aluminoborate glasses detailed in this disclosure after 3 days, <40 kPa, were lower than reported sheer stresses for the removal of barnacles attached to silicone coatings, ca. 60 kPa [Rittschof et al., “Barnacle reattachment: a tool for studying barnacle”, Biofouling, 24, 1 (2008)], which are widely used fouling resistant materials. Furthermore, as shown in FIG. 12, hard foulers can damage soft silicone coatings and permanently adhere to the underlying substrates, and these coatings are susceptible to damage during cleaning processes (i.e. scraping off foulants).

The currently claimed surface-active glasses have a distinct advantage over such coatings, in that, once removed a new reaction layer rapidly forms in aqueous environments; thus, presenting a regenerative anti-fouling interface that can be removed without consequence.

Also, diffusion-limited reaction layers greatly extend the operational lifetime of the glass and preserve the inherent optical and mechanical properties of the bulk glass. Therefore, surface-active glasses are suitable from applications where optical transmission is critical (e.g. windows), as well as incorporated with a variety of different materials, coatings, and composites.

In addition to traditional glass applications (e.g. windows, slides), these new surface-active glasses can be bonded to metal surfaces using sealing glasses, such as barium lanthanoborate glasses described by Brow et al., U.S. Pat. No. 5,648,302, that hermetically seal to titanium and titanium alloys. These surface-active glasses can be applied to metal surfaces coated with a sealing glass in either particulate form or as pre-formed glass article (e.g. glass plate).

Alternative applications are materials or composites consisting of glass fibers. Woven glass composed of surface active glasses would retain anti-fouling properties while exhibiting mechanical properties that may be more desirable than bulk glass for applications where transparency is not crucial.

While graphite was selected as the carbon source in the description of the invention, Landa et al., U.S. Pat. No. 7,562,538, detailed the use of other carbon-containing compounds, with the general chemical composition CₓH_{y}O_{z}•nH₂O, as alternative reducing agents to elemental carbon for the refinement of silicate glasses. Similarly, other carbonaceous compounds that produce carbon as a result of their decomposition in the glass melt can be used to manufacture these surface-active glasses.

Many modifications and variations of the present invention are possible in light of the above teachings. It is therefore to be understood that the claimed invention may be practiced otherwise than as specifically described. Any reference to claim elements in the singular, e.g., using the articles “a,” “an,” “the,” or “said” is not construed as limiting the element to the singular.

What we claim is:

1. A method of making a surface-active glass as regenerative anti-fouling material comprising:
mixing Na₂O and B₂O₃; and
creating a surface-active glass with a water-soluble glass matrix;
wherein the surface-active glass comprises a sodium borate glass consisting of 25 mol % Na₂O and 75 mol % B₂O₃ or wherein the surface-active glass comprises a sodium aluminoborate glass consisting of 10-30 mol % Al₂O₃, 10-30 mol % Na₂O and 70-40 mol % B₂O₃.

2. The method of making a surface-active glass as regenerative anti-fouling material of claim 1 further comprising:
adding a carbonaceous compound to manipulate the dissolution rate of the glass matrix.

3. The method of making a surface-active glass as regenerative anti-fouling material of claim 2 wherein the carbonaceous compound is one selected from the group consisting of graphite, coke, and combinations thereof.

4. The method of making a surface-active glass as regenerative anti-fouling material of claim 1 further comprising the step of:
doping the surface-active glass with a biocidal additive.

5. The method of making the surface-active glass as regenerative anti-fouling material of claim 4 wherein the biocidal additive is one selected from the group consisting of Cu, Ag, and combinations thereof.

6. The method of making the surface-active glass as regenerative anti-fouling material of claim 1 further comprising the step of:
adding an additional glass modifier to the surface-active glass that forms a reaction layer as the glass matrix dissolves.
